(19) United States
(12) Patent Application Publication
(10) Pub. No.: US 2007/0221694 A1
(43) Pub. Date: Sep. 27, 2007

(54) Electronic Device Holder

(76) Inventors: Eliberto R. Aguiliar, Waterford, WI (US); Minerva R. Aguilar, Waterford, WI (US); Eliberto R. Aguilar JR., Waterford, WI (US); Jessica M. Aguilar, Waterford, WI (US)

Correspondence Address: GEHRKE & ASSOCIATES, S.C., 123 N. 86th ST, WAUWATOSA, WI, 53226, US

(21) Appl. No.: 11/277,496

(22) Filed: Mar. 25, 2006

(51) Int. Cl. B62J 7/06

(52) U.S. Cl. 224/420; 224/929

(57) ABSTRACT

The present invention provides an electronic device holder that is removably mounted on the handlebars of a bicycle or motorcycle. This device is designed to receive and stabilize electronic devices such as optical disk players, electronic media players and mobile telephones.

### CROSS-REFERENCE TO RELATED APPLICATIONS

None.

### BACKGROUND OF THE INVENTION

1. Field of Invention

The present invention relates to an electronic device holder for a bicycle. In particular, the present invention includes a means to attach a holder to the handlebars of a bicycle or a similar vehicle. The holder is capable of holding electronic devices, such as an optical disk player, an electronic media player, a tape player, or a mobile phone.

2. Description of the Prior Art

Traditionally equipment carriers are attached to the handlebars of bicycles and motorcycles and have been used for storage of different supplies and for carrying large articles which could not be carried in the pockets of the bicycle or motorcycle operator. Recently, with the popularity of mobile phones, media players, and optical disk players, bicycle and motorcycle operators have wanted to listen to music or talk on the telephone while riding their equipment. In the past, to accomplish this task the various pieces of equipment have been attached to the operator with straps and other devices. These carrying devices, however, have had limited success because of the inability of the operator to view the window of and/or adjust the particular electronic device.

Therefore, what is needed is an electronic carrying device that is attached directly to the handlebars of a bicycle or motorcycle. What is further needed is a carrying device that securely held in place an optical disk player without the player “skipping” while being used. Finally, what is needed is a carrying device that allowed a user to secure other important items such as keys or money in the same location as the electronic device.

### BRIEF SUMMARY OF THE INVENTION

It is an object of the present invention to provide a device for holding an electronic device.

It is a further object of the present invention to provide a securing device.

Further objects and advantages of the invention will become apparent upon review of the drawings, detailed description of the device, and the appended claims.

### BRIEF DESCRIPTION OF THE SEVERAL VIEWS OF THE DRAWING

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is a perspective view of a carrier according to the present invention;

FIG. 2 is a perspective view of an alternative embodiment of a locking device to secure an electronic equipment carrier to the handlebars of a bicycle or motorcycle according to the present invention;

FIG. 3 is a top view of a slotted strip which is part of the locking device according to the present invention;

FIG. 4 is a side view of a screw which is part of the locking device according to the present invention;

FIG. 5 is a side view of a housing which is part of the locking device according to the present invention;

FIG. 6 is a perspective view of a mobile phone holder that is attached to the handlebars of a bicycle or a motorcycle according to an alternative embodiment of the present invention;

FIG. 7 is a perspective view of a mobile phone holder that is attached to the handlebars of a bicycle or a motorcycle according to an alternative embodiment of the present invention;

FIG. 8 is a side view of a securing device of a mobile phone holder according to an alternative embodiment of the present invention;

FIG. 9 is a back view of a securing device of a mobile phone holder according to an alternative embodiment of the present invention;

FIG. 10 is a side view of an optical disk holder according to an alternative embodiment of the present invention;

FIG. 11 is a top view of an optical disk holder according to an alternative embodiment of the present invention;

FIG. 12 is a top view of an optical disk holder according to an alternative embodiment of the present invention;

FIG. 13 is a top view of an attachable strip according to an alternative embodiment of the present invention;

FIG. 14 is a top view of an optical disk holder according to an alternative embodiment of the present invention;

FIG. 15 is a side view of a securing device for an electronic carrier according to the preferred embodiment of the present invention;

FIG. 16A is a front view of a pair of screws of the securing device for an electronic carrier according to the preferred embodiment of the present invention;

FIG. 16B is a side view of a securing device for an electronic carrier for a mobile phone according to the preferred embodiment of the present invention;

FIG. 17 is a side view of a securing device for an electronic carrier for an optical disk or MP3 player or similar electronic media player according to the preferred embodiment of the present invention;

FIG. 18 is a perspective view of an electronic carrier for an optical disk player according to the preferred embodiment of the present invention; and

FIG. 19 is a perspective view of an electronic carrier for an MP3 player or similar electronic media player or iPod® according to the preferred embodiment of the present invention.

### DETAILED DESCRIPTION OF THE INVENTION

As illustrated in FIG. 1, a bicycle includes a pair of handlebars 10. A securing device 12 secures a carrier assembly 14 to handlebars 10. In particular, carrier assembly 14 includes a top foam piece 20 and a bottom foam piece 22. Foam pieces 20 and 22 are attached to one another to receive and sandwich an electronic device such as an optical disk player 18 in the middle via a strap 16. Carrier assembly 14 is an alternative embodiment of the present invention.

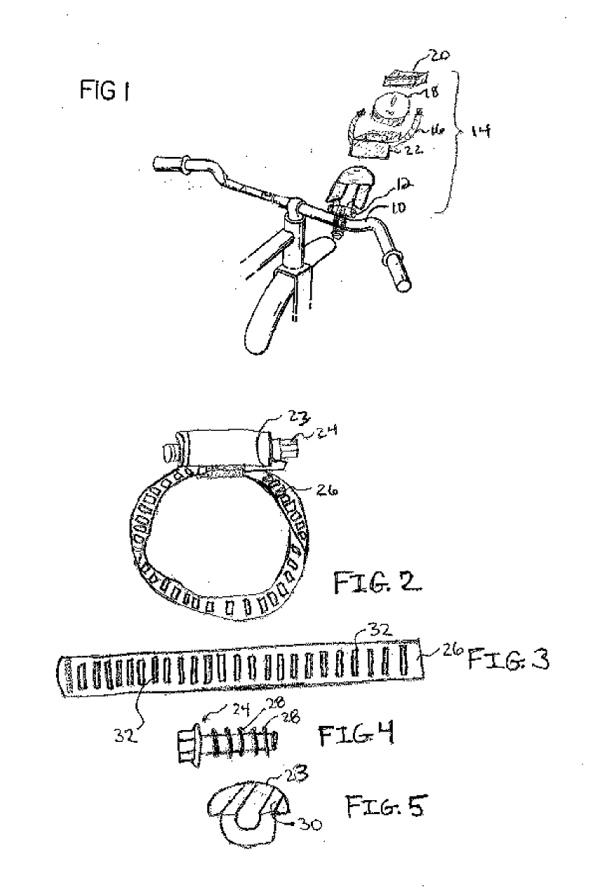

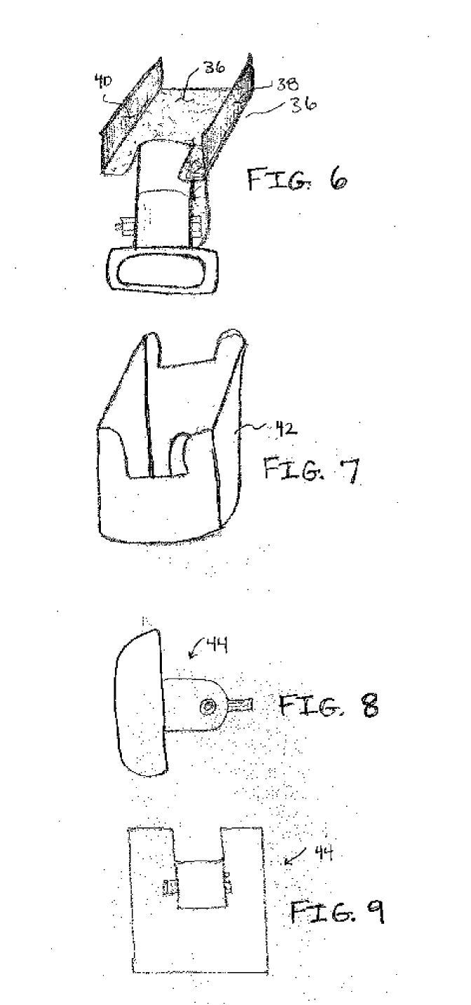

FIGS. 2-5 illustrate a securing device 12 including a screw housing 23, a locking screw 24 and a slotted strip 26. Strip 26 fits around handlebars 10 of varying diameters and is frictionally adjusted by turning locking screw 24. A series of threads 28 on screw 24 engage a series of depressions 30 on the inside of screw housing 23. Threads 28 further engage a series of slots 32 in strip 26 to shorten strip 26 around handlebars 10 and hold carrier assembly 14 in place.

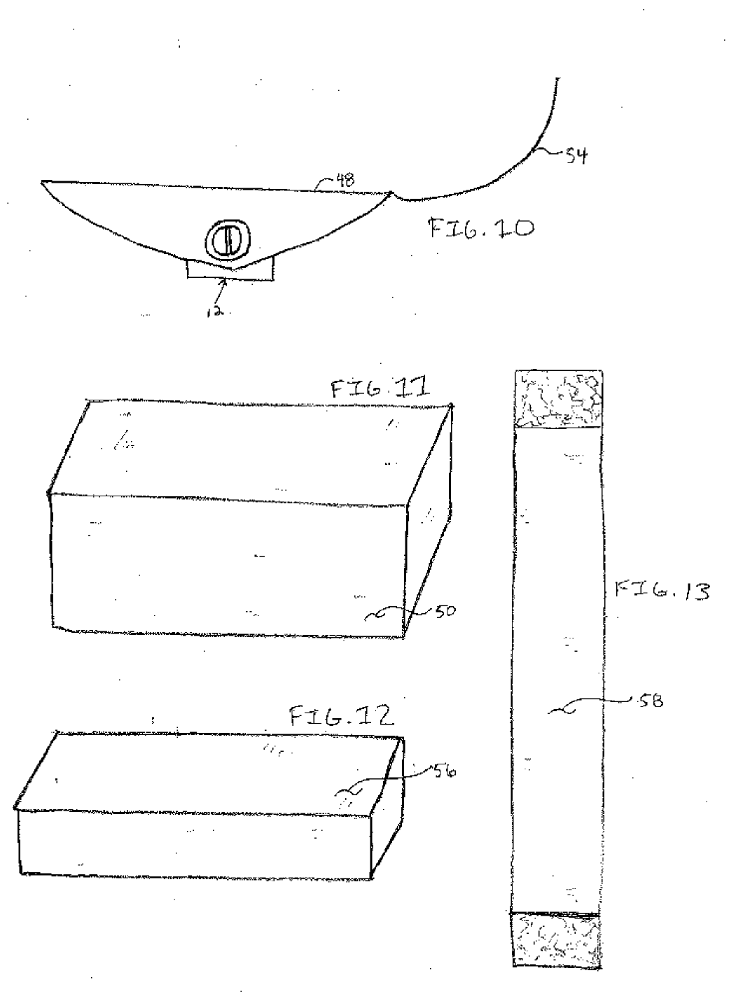

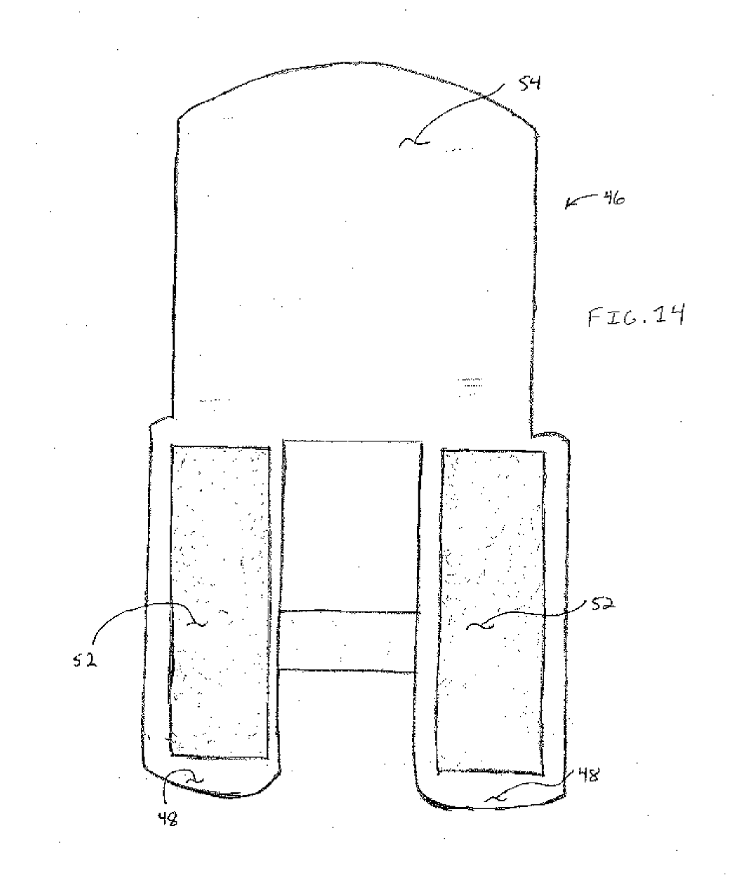

FIGS. 6-9 illustrate a mobile phone holder according to one embodiment of the present invention. A housing 34 includes a Velcro® covered back 36, a side wall 38 and another side wall 40. A mobile phone is removably attached to Velcro® covered back 36 with Velcro® attached to the back of a mobile phone. Housing 34 may also be configured to hold a mobile phone carrier 42. Both holders 42 and 36 may pivot using a pivot joint 44.

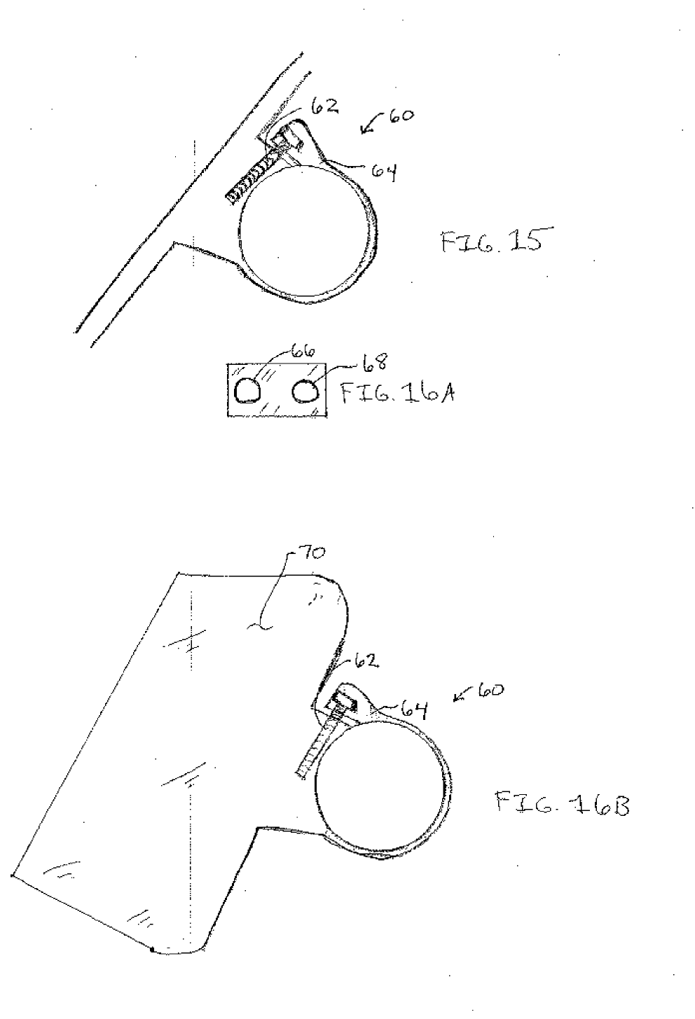

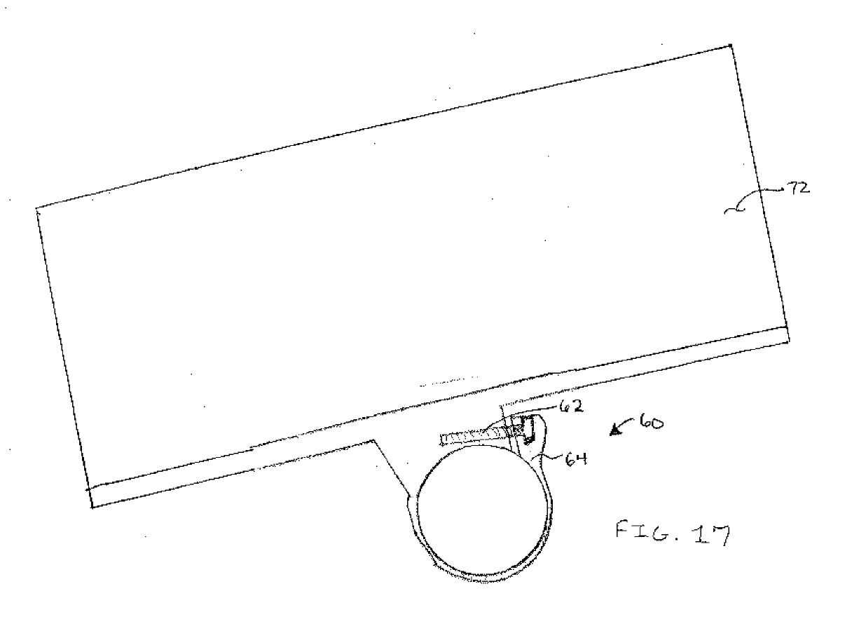

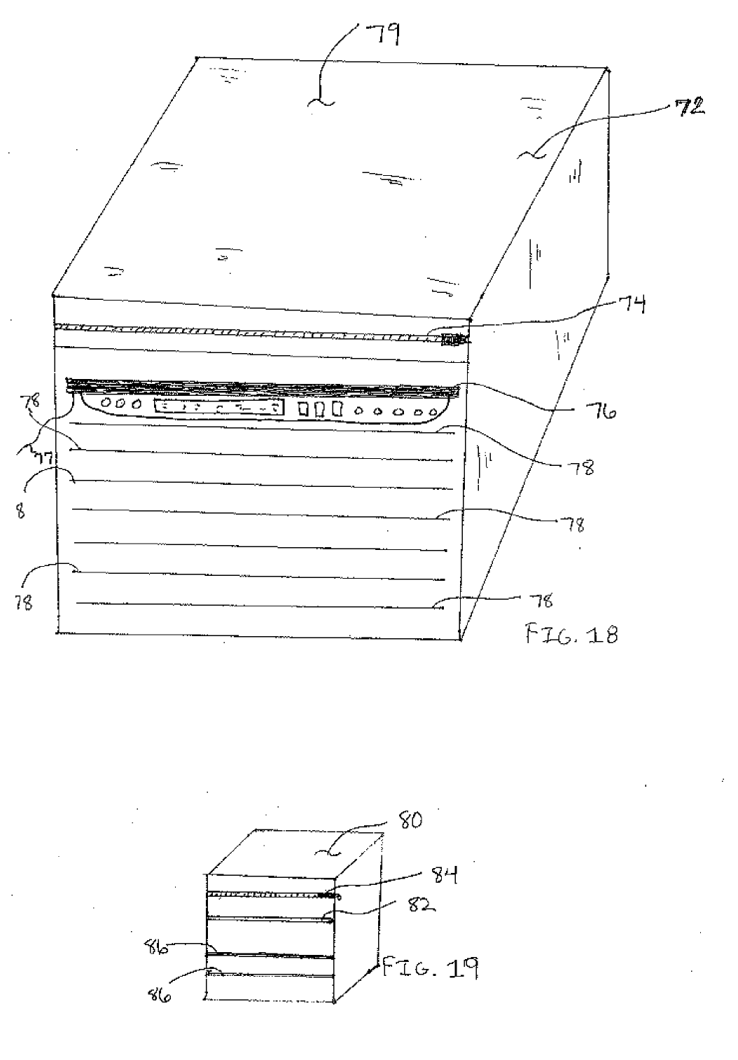

FIGS. 10-14 illustrate another embodiment of the present invention including an optical disk holder 46. Securing device 12 is affixed to a bottom plate 48 of optical disk holder 46. In an alternative embodiment of the present invention, a bottom piece of foam 50 is held in place with mating strips 52 (e.g., Velcro®). A back plate 54 is curved so when holder 46 is tipped to a different position, foam 50 and a top foam piece 56 will not fall off of plate 48. A strip 58 is tied around foam 50 and foam 56 with an optical disk player therebetween to secure the optical disk player from moving. Foam 50 and 56 ensure that the optical disk player does not skip while being used on a bicycle or motorcycle.

FIGS. 15-17 illustrate a securing apparatus 60 according to the preferred embodiment of the present invention. In particular, apparatus 60 includes a threaded socket head bolt 62, and a molded plastic ring 64. Ring 64 is place over handlebars 10 and screwed into place. In the preferred embodiment, a pair of bolts 62 fit through a pair of apertures 66 and 68. Plastic ring 64 is integrally molded with a mobile phone holder 70 (FIG. 16B) or an optical disk holder 72 (FIG. 17). Various electronic items can be clipped to a tube 63 that is integral with securing apparatus 60 (FIG. 15). For example, a mobile phone can be clipped onto tube 63 and secured onto handlebars 10 with ring 64.

As illustrated in FIG. 18, holder 72 is covered with a rain-resistant weatherproof material that is zipped over holder 72. This material may include bright fabrics having logos and pictures of popular licensed TV characters or musicians.

Holder 72 is typically manufactured with lightweight foam and includes a zipper slot 74 capable of holding keys, money and other important personal items. An optical disk player is slipped into an optical disk slot 76 that is wide enough and deep enough to accommodate players of varying sizes. A series of optical disk slots 78 in holder 72 store optical disks an operator may want to use during a ride. The optical disk player may be slipped into slot 76 so that a window of the optical disk player protrudes from slot 76 just enough to allow an operator to control the player. There is also enough clearance on each side of slot 76 when the optical disk player is inserted to allow the headphone cord 77 to protrude.

In an alternative embodiment of the present invention, the optical disk player may be placed on a top surface 79 of holder 72 and an optical disk holder covering may secure the player in place. The covering may be removed and held in place with a zipper closure located underneath holder 72.

A MP3 or similar electronic media player holder 80 is similar in manufacture to optical disk holder 72, but is substantially smaller to accommodate the smaller size of typical MP3 player or similar electronic media players in a slot 82. A zipper slot 84 also accommodates personal items. Additional slots 86 are provided to store any additional items an operator may want to use during a ride.

The scope of the application is not to be limited by the description of the preferred embodiments described above, but is to be limited solely by the scope of the claims that follow. For example, instead of manufacturing the optical disk or electronic media player holder as a plastic apparatus, the holders may be manufactured with other materials, such as steel or aluminum, without departing from the scope of the preferred embodiment of the present invention. Additionally, the various holders may be manufactured as an integral piece or they may be manufactured as separately molded components held together with a particular adhesive.

1. An electronic device holder comprising:
an electronic device enclosure including a top, a bottom, and at least one strap connecting a top of the enclosure to a bottom of the enclosure;
a bracket for attaching an electronic device enclosure to a non-motorized vehicle;
wherein the enclosure further includes storage means for storing personal items.

2. The electronic device holder of claim 1, wherein the enclosure is configured to hold a mobile telephone.

3. The electronic device holder of claim 1, wherein the enclosure is configured to hold an MP3 player or similar electronic media player.

4. The electronic device holder of claim 1, wherein the enclosure is configured to hold an optical disk player.

5. The electronic device holder of claim 1, wherein the at least one strap is removably connected to the top and the bottom of the enclosure.

6. The electronic device holder of claim 1, further comprising a series of slots formed within the top of the enclosure to hold optical disks.

7. An electronic device holder comprising:
an electronic device enclosure including a top, a bottom, and a pair of straps connecting a top of the enclosure to a bottom of the enclosure;
a bracket for attaching an electronic device enclosure a non-motorized vehicle;
wherein the enclosure further includes storage means for storing personal items.

8. The electronic device holder of claim 7, wherein the enclosure is configured to hold a mobile telephone.

9. The electronic device holder of claim 7, wherein the enclosure is configured to hold an MP3 player or similar electronic media player.

10. The electronic device holder of claim 7, wherein the enclosure is configured to hold an optical disk player.

11. The electronic device holder of claim 7, wherein the pair of straps are removably connected to the top and the bottom of the enclosure.

12. The electronic device holder of claim 7, further comprising a series of slots formed within the top of the enclosure to hold optical disks.

13. An electronic device holder comprising:
an electronic device enclosure including a top, a bottom, and at least one strap connecting a top of the enclosure to a bottom of the enclosure; and
a bracket for attaching an electronic device enclosure a non-motorized vehicle.

14. The electronic device holder of claim 13, wherein the enclosure further includes storage means for storing personal items.

15. The electronic device holder of claim 13, wherein the enclosure is configured to hold a mobile telephone.

16. The electronic device holder of claim 13, wherein the enclosure is configured to hold an MP3 player or similar electronic media player.

17. The electronic device holder of claim 13, wherein the enclosure is configured to hold an optical disk player.

18. The electronic device holder of claim 13, wherein the at least one strap is removably connected to the top and the bottom of the enclosure.

19. The electronic device holder of claim 13, further comprising a series of slots formed within the top of the enclosure to hold optical disks.

20. The electronic device holder of claim 14, wherein the personal items include a set of keys.
